(19) United States
(12) Patent Application Publication
(10) Pub. No.: US 2026/0041091 A1
(43) Pub. Date: Feb. 12, 2026

(54) PHYTOREGULATOR FOR PLANTS

(71) Applicant: Shared-X LLC, Menlo Park, CA (US)

(72) Inventor: Jose Antonio de Cote, Miami, FL (US)

(73) Assignee: Shared-X LLC, Menlo Park, CA (US)

(21) Appl. No.: 19/359,467

(22) Filed: Oct. 15, 2025

Related U.S. Application Data
(63) Continuation of application No. 19/072,903, filed on Mar. 6, 2025, now abandoned.
Application No. 19/072,903 is a continuation of application No. 17/658,644, filed on Apr. 8, 2022, now abandoned.
(60) Provisional application No. 63/201,058, filed on Apr. 9, 2021.

(51) Int. Cl. A01N 43/36; A01N 59/00; A01N 65/03

(52) U.S. Cl. CPC A01N 43/36; A01N 59/00; A01N 65/03

(57) ABSTRACT

A phytoregulator composition including L-proline, kaolin, and optionally brown algae in wettable powder form for use in plants in flowering and fruiting stages of life is provided.

### INCORPORATION BY REFERENCE

An Application Data Sheet is filed concurrently with this specification as part of the present application. Each application that the present application claims benefit of or priority to as identified in the concurrently filed Application Data Sheet is incorporated by reference herein in their entireties and for all purposes.

### BACKGROUND

During agricultural crop generation, plants grow under conditions that may be particularly efficient and/or productive. Some plants may benefit from phytoregulators to improve healthy, efficient growth.

The background description provided herein is for the purposes of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One aspect involves a phytoregulator composition for application to plants, the phytoregulator composition including: L-proline; and kaolin.

In various embodiments, the L-proline has a concentration of at least about 20% by weight of the phytoregulator composition.

In various embodiments, the kaolin has a concentration of at least about 20% by weight of the phytoregulator composition.

In various embodiments, the phytoregulator composition includes no other amino acids.

In various embodiments, the phytoregulator composition has an amino acid content and at least 90% of the amino acid content includes L-proline.

In any of the above described and various embodiments, the concentration of L proline is at least about 60% by weight.

In any of the above described and various embodiments, the concentration of L proline is about 63% by weight and the concentration of kaolin is about 37% by weight.

In any of the above described and various embodiments, the phytoregulator composition also includes a trace amount of an element selected from the group consisting of potassium, calcium, magnesium, iron, manganese, boron, and any combination thereof.

In any of the above described and various embodiments, the phytoregulator composition also includes brown algae or a component thereof. In some embodiments, the brown algae includes Laminaria.

In some embodiments, the brown algae has a concentration of at least about 20% by weight of the phytoregulator composition.

In some embodiments, the L-proline has a first dry weight, and the kaolin has a second dry weight, and the brown algae has a third dry weight, and a ratio of the first dry weight to the second dry weight to the third dry weight is about 1:1:1.

In some embodiments, the weight percentages of L-proline, kaolin, and dried brown algae are about 20% to about 50%.

In any of the above described and various embodiments, the L-proline and the kaolin have a weight ratio of about 2:1 to about 1:2.

In any of the above described and various embodiments, the phytoregulator composition also includes water.

In any of the above described and various embodiments, the phytoregulator composition has a density of between about 0.4 gr/ml and about 0.7 gr/ml.

Another aspect involves a method of applying the phytoregulator composition of any of the preceding embodiments to a plant, the method including applying the phytoregulator composition to plants directly on foliage of the plant.

In various embodiments, the method also includes applying the phytoregulator composition on a plant at a stage before the plant flowers.

In various embodiments, the method also includes applying the phytoregulator composition on a plant at a stage before the plant produces fruit.

Another aspect involves a method of producing a phytoregulator composition including: providing L-proline; providing kaolin; and mixing L-proline and kaolin in a mixture.

In various embodiments, the method also includes providing brown algae or a component thereof and mixing the brown algae or component thereof in the mixture.

In some embodiments, the brown algae includes Laminaria.

Another aspect involves a phytoregulator composition for application to plants, the phytoregulator composition consisting essentially of: L-proline; and kaolin.

Another aspect involves a phytoregulator composition for application to plants, the phytoregulator composition consisting essentially of: L-proline; kaolin; and brown algae.

These and other aspects are described further below with reference to the drawings.

### BRIEF DESCRIPTION OF THE DRAWINGS

FIGS. 1A and 1B are schematic illustrations of components of example phytoregulators in accordance with certain disclosed embodiments.

FIG. 2 is a process flow diagram depicting operations performed in a method performed in accordance with certain disclosed embodiments.

FIG. 3 is a process flow diagram depicting operations performed in a method performed in accordance with certain disclosed embodiments.

FIG. 4 is a schematic illustration depicting an example technique for applying a phytoregulator in accordance with certain disclosed embodiments.

### DETAILED DESCRIPTION

In the following description, numerous specific details are set forth to provide a thorough understanding of the presented embodiments. The disclosed embodiments may be practiced without some or all of these specific details. In other instances, well-known process operations have not been described in detail to not unnecessarily obscure the disclosed embodiments. While the disclosed embodiments will be described in conjunction with the specific embodiments, it will be understood that it is not intended to limit the disclosed embodiments.

Agricultural crop generation involves consideration of various factors to ensure healthy and productive growth of the crops, including the geographical location and growth conditions. However, crops may encounter various agricultural growth difficulties, including soil contamination, genetic mutations, pests (such as insects), disease (e.g., fungal, bacterial, and viral diseases), disruptive effects of automated techniques (e.g., tilling, planting, harvesting, watering, etc.), and other non-ideal growing conditions such as soil composition, humidity (excessive or very low), temperature (very high or very low), luminosity level (e.g., excess solar luminosity or lack thereof), flooding and/or drought, stress caused by fertilizers, inadequate pollination, excess of soil salts (e.g., minerals), and lack of organic material and/or minerals in the soil.

To help resolve these agricultural growth difficulties, it is useful to use substances that can assist the plant in its growth and life by providing protection to the plant so the plant can utilize its resources more effectively, or by inducing functions in the plant to improve its growth in different stages of life. One type of substance that may be used in this way is a phytoregulator. Phytoregulators manage environmental conditions, provide protection to the plant to maintain and improve its growth, and induce or catalyze metabolic pathways in the plant to enhance different stages of the plant's life cycle, such as by increasing generation of fruit, increasing flowering, improving the qualities of generated fruit, improving the health and viability of seeds in fruit and/or flowers, and other functions. While some phytoregulators may be used independently, the synergistic effect of a particular selection of phytoregulator components may provide a greater benefit to the plant than either component used alone. In some embodiments, phytoregulators may be used with biostimulant compositions, or combinations of phytoregulators may be used with biostimulant compositions, for synergistic improvement in the growth and development of the plant. “Biostimulant composition” or “nutritional corrector composition” may refer to a composition, which may be a substance or mixture, that supplements or corrects nutritional deficiencies in a plant to improve the function of the plant by stimulating biological processes, improving the availability of nutrients, optimizing the plants'absorption of nutrients, increase tolerance to abiotic stresses, and/or improve quality aspects of the harvest.

Provided herein are phytoregulator compositions that contain L-proline and a thermoregulator. One example thermoregulator is kaolin. Kaolin can be used as a protector against fly and mosquito pests. Kaolin can cover crops, reflect ultraviolet and infrared radiation from the sun, and reduce evapotranspiration. Kaolin, white, soft and plastic clay, is composed mainly of fine-grained laminar particles.

Phytoregulator compositions disclosed herein may also include seaweed and/or algae. One example seaweed is a brown algae or a kelp. One example brown algae that may be used is Laminaria. One example algae that may be used is Ascophyllum nodosum.

In some embodiments, at least about 80% to about 90% of the amino acid content in the phytoregulator composition is free L-proline. In some embodiments, at least about 90% of the amino acid content in the phytoregulator composition is free L-proline. In some embodiments, 100% of the amino acid content in the phytoregulator composition is free L-proline.

In some embodiments, the phytoregulator composition consists essentially of L-proline, and kaolin. In some embodiments, the phytoregulator composition consists essentially of L-proline, kaolin, and seaweed. In some embodiments, the phytoregulator composition consists essentially of L-proline, kaolin, and brown algae. In some embodiments, the phytoregulator composition consists essentially of L-proline, kaolin, and Laminaria. In some embodiments, the phytoregulator composition consists essentially of L-proline, kaolin, and Ascophyllum nodosum.

Phytoregulator compositions described herein utilize synergistic effects of multiple phytoregulators to improve the function of plants of many types. “Phytoregulator composition” may refer to a wettable powder having at least L-proline and kaolin. In some embodiments, phytoregulator compositions are mixtures of processed powders of different sources.

Certain disclosed phytoregulator compositions may include organic acids and amino acid derivatives and coadjuvants. In some embodiments, kaolin functions as a coadjuvant. Phytoregulator compositions may include nitrogen, organic matter, potassium, calcium, magnesium, iron, and manganese.

Phytoregulator compositions disclosed herein may enhance or stimulate induction, synchronization, and increasing of crop flowering. In some embodiments, a phytoregulator acts directly on metabolic and/or physiological pathways associated with flowering and may increase crop yield. Phytoregulator compositions disclosed herein may enhance or stimulate induction, sugar content, and ripening of fruits in crops. In some embodiments, a phytoregulator acts directly on metabolic and/or physiological pathways associated with fruiting and may increase crop yield, improve size of fruits, improve color of fruits, and improve brix degrees of fruits. Phytoregulator compositions described herein may be hormone-free. Phytoregulator compositions may be used on various plants, including but not limited to horticultural crops, strawberries, berry fruits, citrus, pome fruit trees, stone fruit trees, olive trees, grapes, and more.

### Phytoregulator Composition

In certain embodiments, a phytoregulator composition includes L-proline and kaolin, and optionally, seaweed or algae. Example seaweeds include brown algae, or in some embodiments, kelp. Phytoregulator compositions may also include organic matter, organic acids, amino acid derivatives, coadjuvants, and nutrients such as nitrogen, potassium, calcium, magnesium, iron, and manganese. Certain phytoregulator compositions described herein are in powder form.

L-proline, or 2-carboxypyrrolidine, is a naturally occurring or chemically synthesized solid amino acid available from various sources.

Kaolin is a calcined aluminum silicate clay available in solid particles which has an average particle size of about 1.4μm. Kaolin may have a chemical composition of between about 51% and about 52.4% silica (silicon dioxide, SiO₂), between about 42.1% and about 44.3% alumina (aluminum (III) oxide, Al₂O₃), about 0.5% iron oxide (iron (III) oxide, Fe₂O₃), and about 1.56% to about 2.50% titanium dioxide (TiO₂). Kaolin may be extracted by mining. While the embodiments described herein generally refer to kaolin, it should be understood that other clay-based materials may replace or supplement kaolin in the disclosed embodiments. Further, non-clay components having similar temperature regulating properties as kaolin may replace or supplement kaolin in the disclosed embodiments.

Example seaweeds that may be used include kelps in the order Laminariales, such as Laminaria, or seaweeds in the order Fucales such as Ascophyllum nodosum. Laminaria is a genus of brown algae or kelp. Laminaria may be harvested in the north Atlantic Ocean or north Pacific Ocean. Laminaria has a high potassium content which can be used to assist in a fruit ripening process of a plant. Ascophyllum nodosum may be harvested from the north Atlantic Ocean.

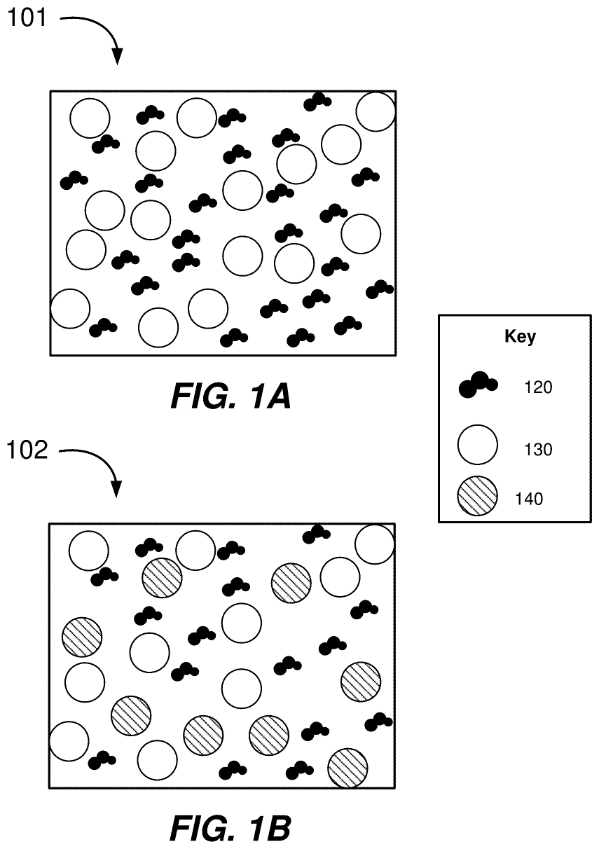

FIG. 1A provides a schematic illustration of a mixture 101 of powders in a phytoregulator composition in accordance with certain disclosed embodiments. Mixture 101 includes L-proline 120 and kaolin 130.

L-proline amino acid has a secondary amino group alpha to the carboxyl group. L-proline can induce flowering in plants by acting directly on the metabolic flowing channel in a plant. The amount of L-proline may be at least about 20% by weight, or about 40% to about 80% w/w by dry weight. In some embodiments, the amount of L-proline is about 62% w/w. Although L-proline is described herein, other amino acids may be used to supplement L-proline.

Kaolin is a type of clay material that can regulate temperature of plants by creating a protective film around a plant to protect it from temperature fluctuations. In some embodiments, kaolin can serve as an insecticide. Kaolin may reduce stress on a plant, such that when paired with L-proline, the synergistic effect of reducing stress and inducing flowering increases flower production in a plant. Although kaolin is described herein, other clay base products may be used. The amount of kaolin may be at least about 20% by weight, or about 20% to about 60% w/w by dry weight. In some embodiments, the amount of kaolin may be about 38% w/w. In some embodiments, the amount of L-proline, and amount of kaolin are the same by dry weight. In some embodiments, the ratio of dry weight of L-proline to dry weight of kaolin is about 1:1. In some embodiments, the amount of L-proline is about 63% and the amount of kaolin is about 37%. In some embodiments, the amount of L-proline is about 30% to about 80% by weight and the remaining amount of the composition may be kaolin. In some embodiments, the amount of L-proline is about 30% to about 80% by weight and the amount of kaolin is about 20% to about 70% by weight.

In some embodiments, mixture 101 has a density of about 0.3 gr/ml to about 0.6 gr/ml. The pH of mixture 101 may be about 6.5 to about 7.5, or about 7.

Mixture 101 may also include additional components, such as organic nitrogen, organic matter, potassium, calcium, magnesium, iron, manganese, and boron. The amount of organic nitrogen may be about 5% w/w to about 7.5% w/w, or about 7% w/w. The amount of organic matter may be about 30% w/w to about 70% w/w, or about 50% w/w to about 60% w/w, or about 55% w/w. Mixture 101 may also include trace amounts of potassium, calcium, magnesium, iron, manganese, and boron. “Trace amounts” may refer to less than about 1% by dry weight, or about 0.5 ppm to about 120 ppm. The amount of potassium may be about 0.4% w/w to about 0.8% w/w, or about 0.6% w/w. The amount of calcium may be about 0.5% w/w to about 0.10% w/w, or about 0.8% w/w. The amount of magnesium may be about 0.5% w/w to about 0.15% w/w, or about 0.1% w/w. The amount of iron may be about 80 ppm to about 140 ppm, or about 110 ppm. The amount of manganese may be about 3 ppm to about 5 ppm, or about 4 ppm. The amount of boron may be about 0.5 ppm to about 2 ppm, or about 1.7 ppm.

Mixture 101 may be suitable for applying to flowering crops such as, but not limited to, horticultural crops, strawberries, berry fruits, citrus, pome fruit trees, stone fruit trees, olive trees, grapes, and ornamental plants. Mixture 101 may be used for flowering crops that are used for pigments. Mixture 101 may be used for crops during or before flowering. Mixture 101 may be applied to various types of flowering plants even in adverse conditions. Kaolin has thermoregulatory capacity and is particularly suitable for use in environmental conditions having extreme heat, such as in the south of Spain, and is effective in reducing stress generated by the extreme temperature.

FIG. 1B provides a schematic illustration of a mixture 102 of powders in a phytoregulator composition in accordance with certain disclosed embodiments. Mixture 102 includes L-proline amino acids 120, kaolin 130, and brown algae 140.

Brown algae aids in the transportation of sugars and/or carbohydrates from leaves of a plant to the fruit, thereby assisting with ripening and fruit production. This helps produce a higher quality final fruit product. Brown algae may be dried and brought to a powder granulometry. The amount of brown algae that may be present may be at least about 20% by weight, or about 20% w/w to about 50% w/w. In some embodiments, the amount of brown algae is about 30% w/w. Brown algae used in mixture 102 may also have a particular sugar content. In some embodiments, the amount of brown algae is about 33% w/w.

In mixture 102, the amount of each of L-proline, kaolin, and brown algae is about 20% to about 60% w/w, or about 20% to about 50% w/w. In some embodiments, the amount of L-proline may be about 20% to about 60% w/w, or about 20% w/w to about 50% w/w. In some embodiments, the amount of L-proline is about 30% w/w. The amount of kaolin may be about 20% w/w to about 50% w/w. In some embodiments, the amount of kaolin may be about 30% w/w. The amount of brown algae may be about 20% to about 60% w/w, or about 20% w/w to about 50% w/w. In some embodiments, the amount of brown algae may be about 30% w/w. In some embodiments, the amount of each of L-proline, kaolin, and brown algae is about 33% w/w. In some embodiments, the amount of L-proline, amount of kaolin, and amount of brown algae are the same by dry weight. In some embodiments, the ratio of dry weight of L-proline to dry weight of kaolin in a mixture with brown algae is about 2:1 to about 1:2. In some embodiments, the ratio of dry weight of kaolin to dry weight of brown algae in a mixture with L-proline is about 2:1 to 1:2. In some embodiments, the ratio of dry weight of L-proline to dry weight of brown algae in a mixture with kaolin is about 2:1 to 1:2. In some embodiments, the ratio of dry weight of L-proline to dry weight of kaolin to dry weight of brown algae is about 1:1:1.

In some embodiments, mixture 102 has a density of about 0.4 gr/ml to about 0.7 gr/ml or about 0.6 gr/ml. The pH of mixture 102 may be about 6.5 to about 8.5, or about 7.

Mixture 102 may be suitable for applying to fruit crops such as, but not limited to, tomatoes, apples, mangoes, avocadoes, berries, and other fruiting crops where flavor, color, and size may be optimized. Mixture 102 may be applied to a crop during fruiting. Mixture 102 may be suitable for use in particular environmental conditions or in geographical areas having certain types of soil. In various embodiments, mixture 102 may be suitable for use in plants that have a specific soil pH.

In both examples of FIGS. 1A and 1B, the mixture is a wettable powder. In some embodiments, the mixture may be suspended in a liquid or mixed in a liquid.

The mixture may be provided in a bilaminated bag with a thermo seal that can act as a humidity barrier to protect kaolin, which is hygroscopic. The lamination on the bag may be used as a ultraviolet (UV) barrier. When the packaged mixture is received and ready for use, the mixture may then be modified at the site of application before applying to crops by diluting it in water. Example dilution is about 80 gr to about 100 gr of the wettable powder mixture is added for every about 100 liters of water. L-proline is water soluble, and kaolin may be suspended particles in the water, periodically mixed to ensure homogeneous mixture in the liquid.

### METHOD OF MAKING PHYTOREGULATOR

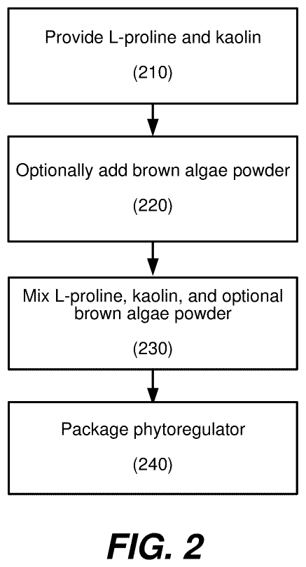

Phytoregulator compositions described herein are made using certain methods. FIG. 2 provides a process flow diagram depicting operations that may be performed in accordance with a certain method embodiment described herein. In operation 210, an amino acid and coadjuvant are provided. An example amino acid is L-proline. An example coadjuvant is kaolin. In some embodiments, these components are dried or ground.

In an operation 220, brown algae is optionally added. Where brown algae is added, brown algae may be processed by being dried, cut, and/or ground into a powder form.

In an operation 230, the amino acid, coadjuvant, and optional brown algae are mixed in a powder form.

In an operation 240, the phytoregulator mixture is packaged. As described above, the mixture may be packaged in a wettable powder form in containers.

### Method Of Using Phytoregulator Composition

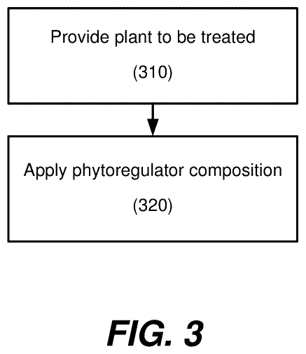

Phytoregulator compositions described herein can be applied to crops or plants in various ways and at different times depending on the composition used. In some embodiments, prior to applying to crops, a phytoregulator composition is mixed with water to dissolve the L-proline and provide a sprayable liquid. FIG. 3 provides a process flow diagram depicting operations that may be performed in accordance with certain embodiments. In an operation 310, the plant to be treated is provided. The plant can be any one of a variety of crops, both ones having intensive short cycles and extensive long cycles. Examples include but are not limited to vegetables, berries, fruit trees, superfoods, and grapes. Certain phytoregulator compositions may be applied to plants in a flowering phase. In some examples, the earliest time in the growth cycle of a plant to apply a phytoregulator composition having L-proline and kaolin is when the plant initially has flower buds to induce more flowers to grow. In some examples, the earliest time in the growth cycle of a plant to apply a phytoregulator composition having L-proline, kaolin, and brown algae is when the plant grows its first fruit to aid in the growth, sugar content, and ripening of the fruit. Certain phytoregulator compositions may be suitable for plants in a fruiting phase. They can be used in organic or conventional farming. Each plant type can utilize a different application regime of phytoregulator to maximize productivity.

In an operation 320, the diluted phytoregulator composition is applied. When the diluted phytoregulator composition is applied depends on the composition of the phytoregulator and the time in the life cycle of the plant it is applied to as described above.

For example, a mixture containing L-proline and kaolin without brown algae may be suitable for applying onto plants just before flowering. A mixture containing L-proline, kaolin, and brown algae may be suitable for applying onto plants just before fruiting. The diluted phytoregulator composition may be applied to a plant in a pot, or a plant grown by hydroponics, or a plant grown in an open field. Each of these types of plants may utilize different amounts of phytoregulator composition.

The diluted phytoregulator composition may be applied to foliage of a plant. Mixtures containing L-proline and kaolin may be applied to inflorescences of a plant. Mixtures containing L-proline, kaolin, and brown algae may be applied to leaves and fruits of a plant.

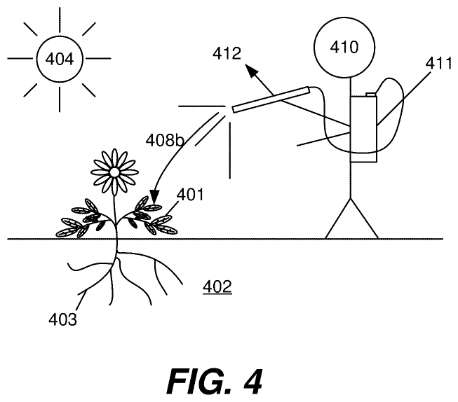

In some embodiments, diluted phytoregulator compositions are applied directly to a plant, such as to the leaves or the foliage of a plant and may be manually applied by a person. An example is provided in FIG. 4 which is a schematic diagram of a plant 401 having roots 403 in soil 402 under a light source 404 whereby the trajectory 408b of a diluted phytoregulator composition is delivered or sprayed via a mister 412 handled by a human 410 from a container 411 of phytoregulator composition. While a mister 412 is depicted in this example, it will be understood that other technologies capable of applying the composition to flowers and fruits may be used, including but not limited to fumigation backpacks and spray booms. Direct application to foliage may be used to allow the composition to be received by the plant through stoma in the leaves. In some embodiments, products may be applied directly to flowers or fruit.

While certain phytoregulator compositions described herein are applied before or after flowering or before or after fruiting, in some embodiments, diluted phytoregulator compositions may be applied at other parts of a plant's life cycle, including but not limited to at seeding, at germination, and at seed development, and diluted phytoregulator compositions may be applied in more than one location on a plant (such as stems, leaves, flowers, fruit, seed pods, etc.) and in more than one stage of plant growth.

Diluted phytoregulator compositions suitable for flowering stages or fruiting stages of a plant may be applied to the plant at least twice in the life cycle of the plant, or at most five times in the life cycle of the plant. Diluted phytoregulator compositions are applied at the start of flowering or during fruiting in the plant life cycle as described above. In some embodiments, the composition is applied continuously throughout the flowering or fruiting stage respectively, periodically throughout the flowering or fruiting stage respectively, only before the flowering or fruiting stage respectively, or a combination thereof. Periodic application may have a frequency of daily, or weekly, or biweekly, or monthly, or as frequently as desired depending on the plant life cycle, duration of flowering or fruiting season, and environmental conditions that may modify the plant's life cycle. In various embodiments, the phytoregulator composition may be applied in multiple applications. A first application may be applied when flowering starts, and one or more subsequent applications are applied before, during, and/or after fruiting. In some embodiments, a second application is performed about seven days after the first application. In some embodiments, a third application is performed about ten days after the second application. In some embodiments, fourth and subsequent applications are performed every twenty days after the third and later applications until fruit starts developing. In some embodiments, no more than about five applications are used during flowering. During the flowering stages, the applied composition may include only L-proline and kaolin. When fruit starts developing, a phytoregulator composition may be applied every about ten to about fifteen days until fruit harvesting. The phytoregulator composition applied during fruiting may be different than during flowering. In some embodiments, when fruit starts developing, the phytoregulator composition applied is changed to a composition having L-proline, kaolin, and seaweed (e.g., brown algae). In some embodiments, no more than about five applications may be used during fruiting.

### CONCLUSION

Although the foregoing embodiments have been described in some detail for purposes of clarity of understanding, it will be apparent that certain changes and modifications may be practiced within the scope of the appended claims. It should be noted that there are many alternative ways of implementing the processes, systems, and apparatus of the present embodiments. Accordingly, the present embodiments are to be considered as illustrative and not restrictive, and the embodiments are not to be limited to the details given herein.

What is claimed is:

1. A phytoregulator composition for application to plants, the phytoregulator composition comprising:
L-proline; and
kaolin.

2. The phytoregulator composition of claim 1, wherein the L-proline has a concentration of at least about 20% by weight of the phytoregulator composition.

3. The phytoregulator composition of claim 1, wherein the kaolin has a concentration of at least about 20% by weight of the phytoregulator composition.

4. The phytoregulator composition of claim 1, wherein the phytoregulator composition includes no other amino acids.

5. The phytoregulator composition of claim 1, wherein the phytoregulator composition has an amino acid content and at least 90% of the amino acid content comprises L-proline.

6. The phytoregulator composition of claim 1, wherein the concentration of L-proline is at least about 60% by weight.

7. The phytoregulator composition of claim 1, wherein the concentration of L-proline is about 63% by weight and the concentration of kaolin is about 37% by weight.

8. The phytoregulator composition of claim 1, further comprising a trace amount of an element selected from the group consisting of potassium, calcium, magnesium, iron, manganese, boron, and any combination thereof.

9. The phytoregulator composition of claim 1, further comprising brown algae or a component thereof.

10. The phytoregulator composition of claim 1, having a density of between about 0.4 gr/ml and about 0.7 gr/ml.

11. A method of applying the phytoregulator composition of claim 1 to a plant, the method comprising applying the phytoregulator composition to plants directly on foliage of the plant.

12. The method of claim 11, further comprising applying the phytoregulator composition on a plant at a stage before the plant flowers.

13. The method of claim 11, further comprising applying the phytoregulator composition on a plant at a stage before the plant produces fruit.

14. A method of producing a phytoregulator composition comprising:
providing L-proline;
providing kaolin; and
mixing L-proline and kaolin in a mixture.

15. The method of claim 14, further comprising providing brown algae or a component thereof and mixing the brown algae or component thereof in the mixture.

16. The method of claim 15, wherein the brown algae comprises Laminaria.

17. A phytoregulator composition for application to plants, the phytoregulator composition consisting essentially of:
L-proline; and
kaolin.

18. A phytoregulator composition for application to plants, the phytoregulator composition consisting essentially of:
L-proline;
kaolin; and
brown algae.

19. The method of claim 12, wherein the phytoregulator composition comprises L-proline and kaolin, and the phytoregulator composition is brown algae-free.

20. The method of claim 13, wherein the phytoregulator composition comprises L-proline, kaolin, and brown algae.
